(19) United States
(12) Patent Application Publication
(10) Pub. No.: US 2005/0280624 A1
(43) Pub. Date: Dec. 22, 2005

(54) Circuit architecture for compensating for brightness and chromatic aberration of an LCD and method thereof

(76) Inventor: Hong-Da Liu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,991

(22) Filed: Jun. 11, 2004

(30) Foreign Application Priority Data
Jun. 27, 2003 (TW) 092117618

(51) Int. Cl. G09G 3/36

(52) U.S. Cl. 345/102

(57) ABSTRACT

Providing a set of calibration gamma curves, and applying different driving voltages to corresponding positions of an LCD according to the set of calibration gamma curves so that at a same gray scale and at a same fundamental color, brightness is identical and no chromatic aberration occurs in all the positions of the LCD.

### BACKGROUND OF INVENTION

1. Field of the Invention

The present invention relates to an LCD (liquid crystal display), and more particularly, to a circuit architecture for compensating for brightness and chromatic aberration of an LCD and method thereof.

2. Description of the Prior Art

As shown in FIG. 1, an LCD 10 normally includes a top substrate 12, a bottom substrate 14, and a liquid crystal layer 16 positioned between the top substrate 12 and the bottom substrate 14. Ideally, the gap between the top substrate 12 and the bottom substrate 14 at any position is identical. In practice, however, the injection of the liquid crystal molecules between the top substrate 12 and the bottom substrate 14 causes a deformation of the top substrate 12 or the bottom substrate 14. This phenomenon is serious particularly for a large size LCD as shown in FIG. 2 and FIG. 3.

Take a normal white transmissive ninety-degree twisted nematic (TN) LCD as an example. The transmission rate can be obtained by the following formula:

$$T = 1 - \frac{{sin}^{2} ( \frac{π}{2} \sqrt{1 + {u}^{2}} )}{1 + {u}^{2}} \\ u = \frac{2 Δ nd}{λ} \qquad Equation 1$$

where T is transmission rate, Δn is liquid crystal phase difference, d is cell gap, and λ is wavelength of light source.

FIG. 2 and FIG. 3 illustrate the bottom substrate 14 respectively bent outward and inward after the liquid crystal layer 16 is injected, and the gaps h1 and h2 at positions P1 and P2 are not identical. Thus the cell gap d of the liquid crystal layer at P1 and P2 are not equal. Since Δn and λ are fixed, different transmission rates will be obtained at P1 and P2 according to Equation 1.

Please refer to FIG. 4, which is a transmission rate vs. driving voltage chart. As shown in FIG. 4, a gamma curve 40 is the inherent gamma curve, and since the substrate is bent, an actual gamma curve may be gamma curve 42 or 44. Ideally, if a transmission rate T0 at P1 and P2 is required, a driving voltage V0 is applied to P1 and P2 according to the gamma curve 40. Unfortunately, the actual gamma curves at P1 and P2 are gamma curve 42 and 44. Therefore, the actual transmission rates at P1 and P2 are respectively T1 and T2 when the applied driving voltage is V0. Consequently, this results in chromatic aberration and brightness differences at P1 and P2.

In addition, a large size LCD TV (for example from 25 to 100 inches) is quite heavy. As a result, liquid crystal molecules 18 of the liquid crystal layer 16 may suffer the influence of gravity as shown in FIG. 5. This may also cause the top substrate 12 and the bottom substrate 14 to have uneven spacing, and therefore generate the problem of brightness difference and chromatic aberration.

Though liquid crystal on silicon (LCOS) displays, which are for projection use, are smaller, and the uneven gap problem is not as apparent, nevertheless, after an image is projected, a LCOS display can suffer from the same problems of brightness difference and chromatic aberration.

Therefore, a circuit architecture for compensating for brightness and chromatic aberration of an LCD is eagerly required.

### SUMMARY OF INVENTION

It is a primary objective of the present invention to provide a circuit architecture for compensating for brightness and chromatic aberration of an LCD.

According to the claimed invention, a circuit architecture for compensating for brightness and chromatic aberration of an LCD and method thereof are proposed. The method of the present invention provides a set of calibration gamma curves, and applies different driving voltages to corresponding positions according to the set of calibration gamma curves so that at a same gray scale and at a same fundamental color brightness is identical and no chromatic aberration occurs in all the positions of the LCD. The circuit architecture of the present invention includes at least a gray scale determination device for determining a gray scale of a position and outputting a gray scale selection signal, a calibration device providing a calibration gamma curve for compensating for brightness and chromatic aberration of the position, and a voltage generating device for generating a driving voltage to the position according to the gray scale selection signal and the calibration gamma curve.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of an ideal LCD.

FIG. 2 and FIG. 3 are schematic diagrams of an actual conventional LCD.

FIG. 4 is a transmission rate vs. driving voltage chart.

FIG. 5 is a schematic diagram of a conventional LCD TV.

FIG. 6 is a transmission rate vs. driving voltage chart.

FIG. 7 is a schematic diagram of an LCD with 1024*768 resolution.

FIG. 8 is a schematic diagram illustrating different areas of an LCD.

FIG. 9 is a schematic diagram demonstrating the interpolation method.

FIG. 10 is a schematic diagram illustrating how to obtain a gamma curve by the interpolation method.

FIG. 11 is a schematic diagram illustrating how to obtain a gamma curve by a formula of center of gravity.

FIG. 12 is a schematic diagram of a circuit architecture for compensating for brightness and chromatic aberration of an LCD according to the present invention.

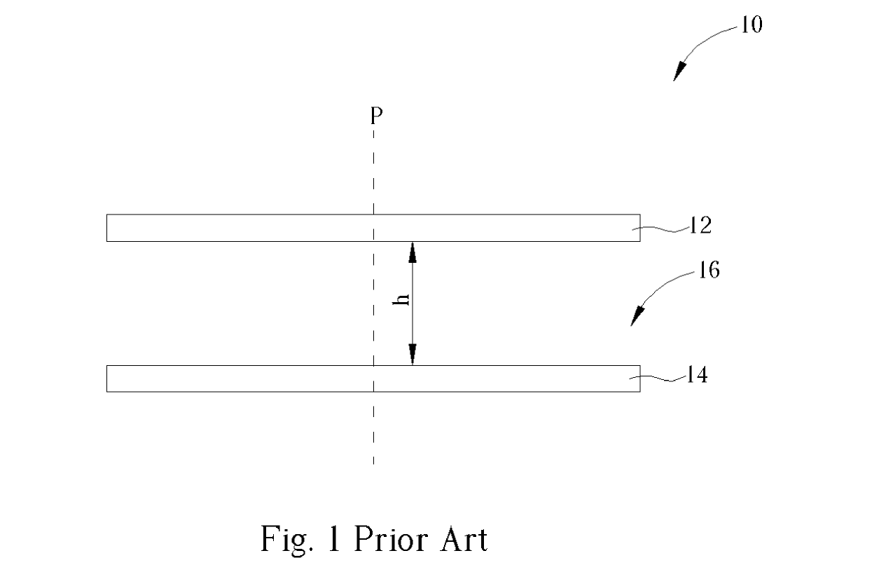

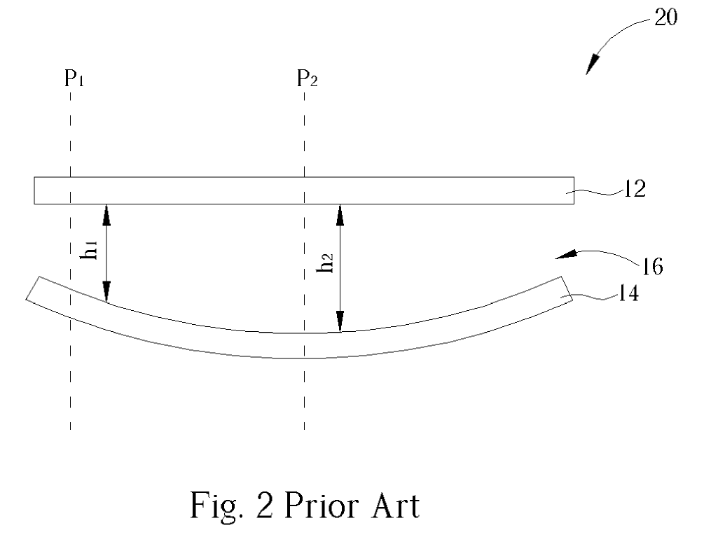

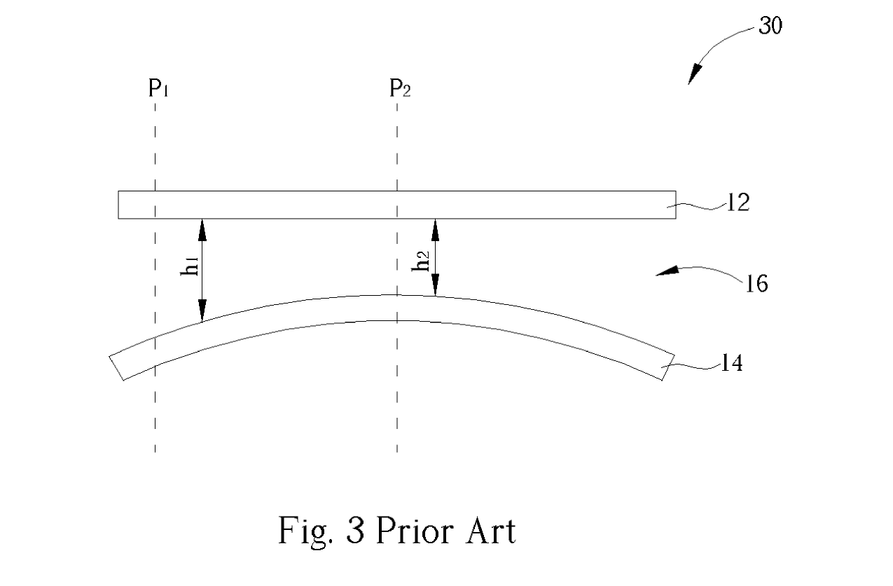

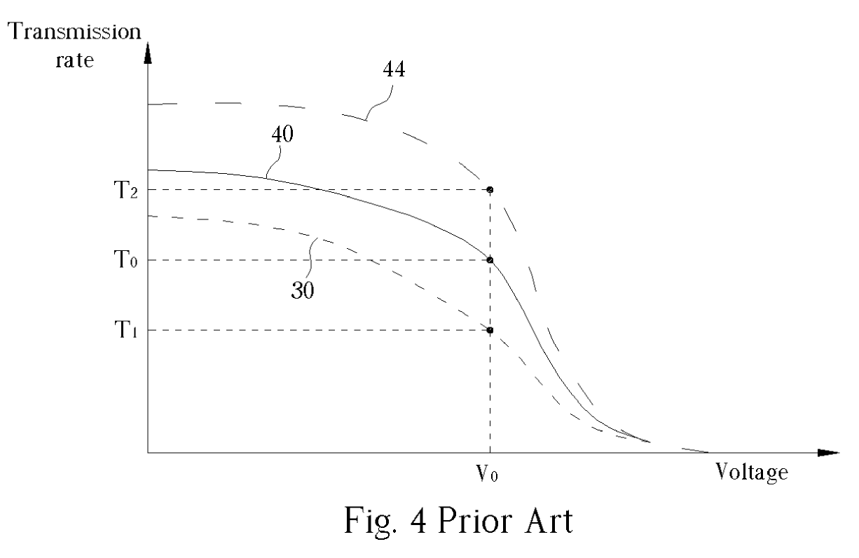

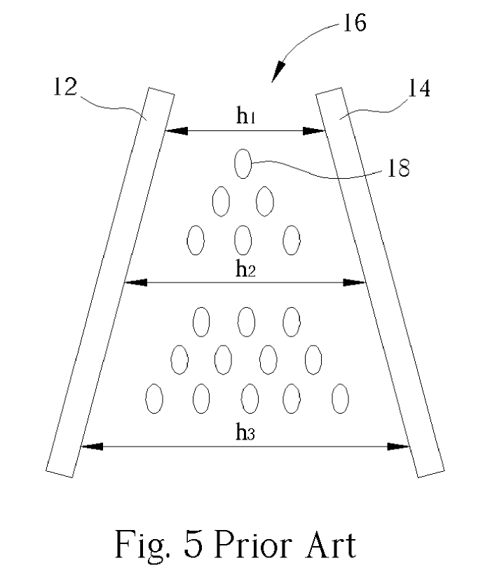

### DETAILED DESCRIPTION

The method of the present invention provides a set of calibration gamma curves, and applies different driving voltages to corresponding positions according to the set of calibration gamma curves so that at a same gray scale and at a same fundamental color, brightness is identical and no chromatic aberration occurs in all the positions of the LCD.

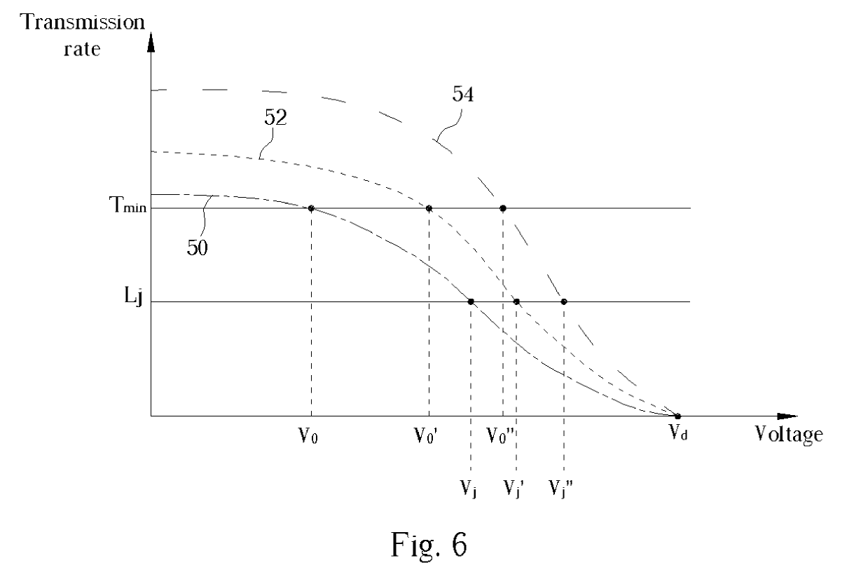

In order to obtain the set of calibration gamma curves, the gamma curves at all positions of the LCD must be detected first, as shown in FIG. 6. Please note that only three gamma curves 50, 52, and 54 at three positions are shown in this embodiment for easy illustration and understanding. The predetermined driving voltage for each gamma curve 50, 52, and 54 ranges from 0 to V_{d}. In this embodiment, the minimum transmission rate Tₘᵢₙ is selected as a basis, and the driving voltage ranges of the gamma curve 50, 52, and 54 are redefined. Please note that Tₘᵢₙ must be a value in a certain range so that each gamma curve has a corresponding driving voltage. Preferably, the range is from 10% to 90% of transmission rate of the lowest gamma curve, and the highest transmission rate is selected as Tₘᵢₙ. After being redefined, the driving voltage range of the gamma curve 50 is between V₀ to V_{d}, the driving voltage range of the gamma curve 52 is between V_{0″} and V_{d}, and the driving voltage range of the gamma curve 54 is between V_{0″} and V_{d}. Consequently, driving voltages Vⱼ, V_{j″}, and V_{j″} at a different gray scale Lⱼ at different positions are obtained. Finally, a set of calibration gamma curves is obtained by normalizing the driving voltages Vⱼ, V_{j″}, and V_{j″} at all different gray scales Lⱼ at all different positions.

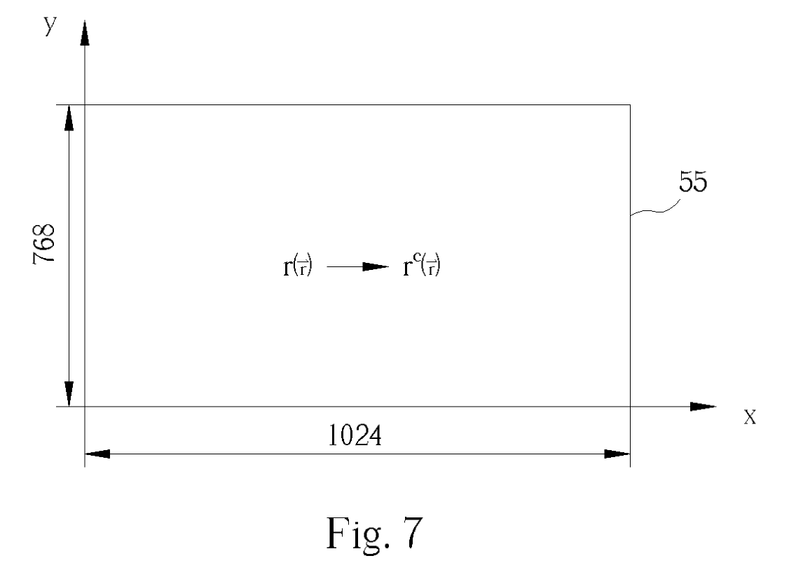

Take a LCD 55 with 1024*768 resolution as an example. As shown in FIG. 7, after normalizing the gamma curve
y(\overline{l}ᵢ)
of all positions, 1024*768 calibration curves
y^{c}(\overline{l}ᵢ)
are obtained, where i represents different positions.

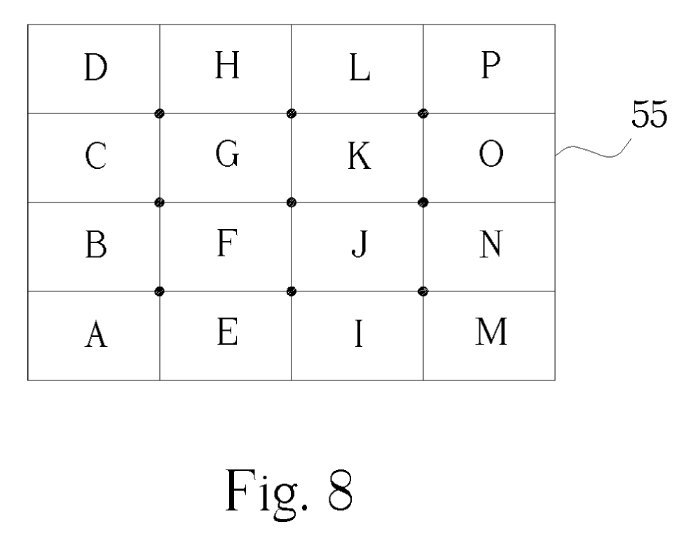

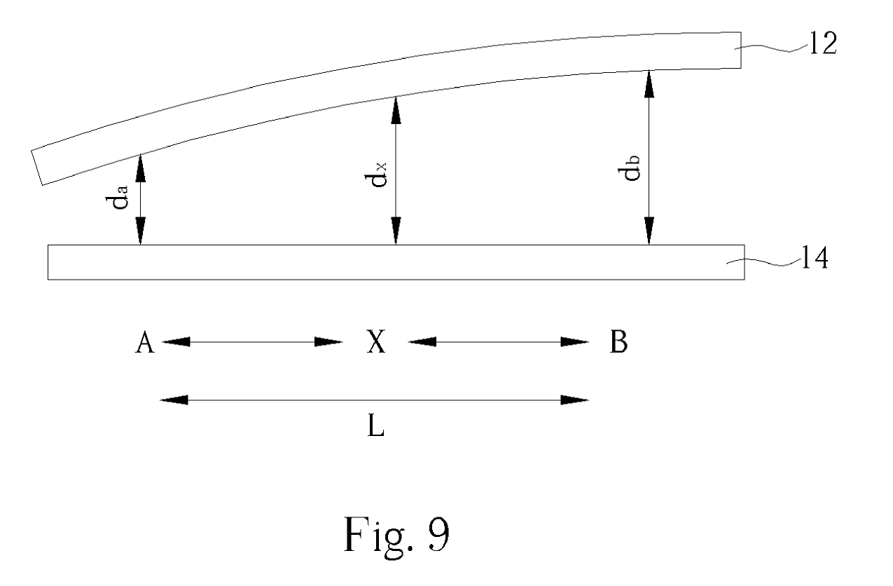

Since the deformation of a substrate is continuous, the substrate can be, for example, divided into nine points (from point 1 to point 9) or 16 areas (from area A to area P) as shown in FIG. 8. Then, an interpolation method is applied to obtain the gamma curves of all points or all areas. FIG. 9 is a schematic diagram demonstrating how the interpolation method is utilized. As shown in FIG. 9, d is a gap between the top substrate 12 and the bottom substrate 14 at A, d_{b} is a gap between the top substrate 12 and the bottom substrate 14 at B, and dₓ is a gap between the top substrate 12 and the bottom substrate 14 at X. In addition, L is the distance from A to B, α is a parameter ranging from 0 to 1, the distance from A to X is α*L, and the distance from B to X is (1−α)*L. When dₐ and d_{b} are given, and L is less than a proper value, dₓ can be obtained by utilizing the interpolation method. The interpolation formula is expressed as follows:

$${D}_{x} \approx {d}_{a} ( 1 - α ) + {d}_{b} α \qquad Equation 2$$

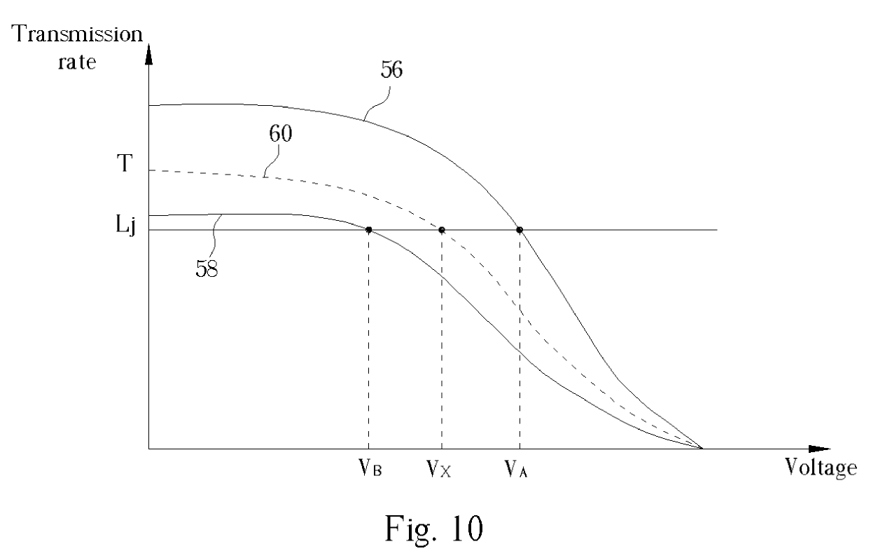

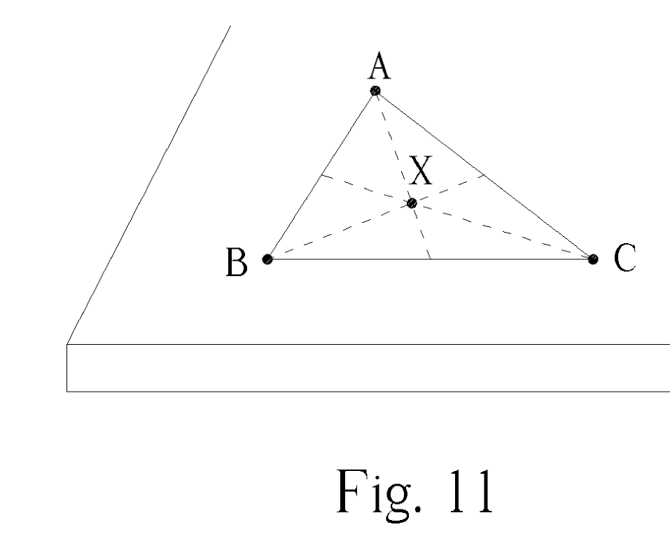

Similarly, if the gamma curves 56 and 58 at A and B are given, the gamma curve 60 can be obtained by the following formula as shown in FIG. 10.

$${V}_{x} \approx {V}_{a} ( 1 - α ) + {V}_{b} α \qquad Equation 3$$

where Vₐ is the driving voltage at gray scale Lⱼ at A, V_{b} is the driving voltage at gray scale Lⱼ at B, and Vₓ is the driving voltage at gray scale Lⱼ at X. In addition to applying the interpolation method, other mathematical methods can also be applied to obtain the gamma curve. For example, a formula for center of gravity can be used as shown in FIG. 11.

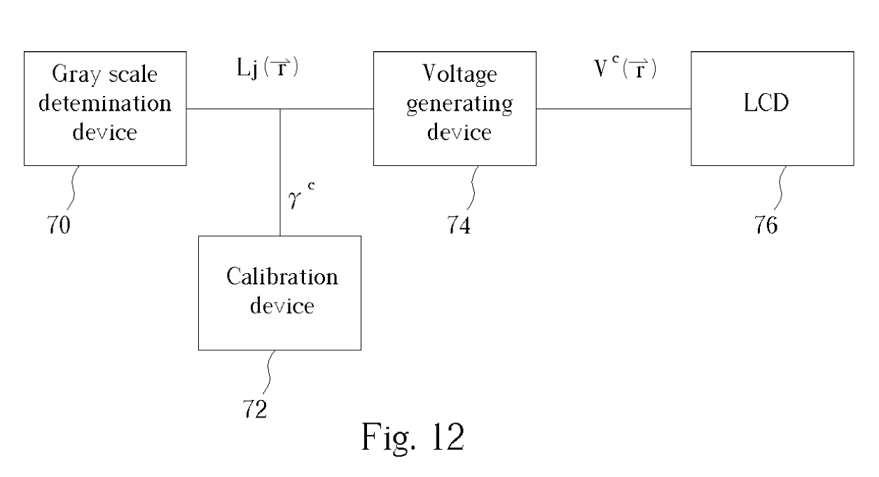

FIG. 12 illustrates a circuit architecture for compensating for brightness and chromatic aberration of an LCD 76. As shown in FIG. 12, the circuit architecture includes a gray scale determination device 70, a calibration device 72, and a voltage generating device 74. The gray scale determination device 70 outputs a gray scale selection signal L

\overline{r}
) at any position
\overline{r}
of the LCD 76. The calibration device 72 provides a calibration
gamma curve
γ^{c}
for compensating for the brightness and the chromatic
aberration of the position
\overline{r}
. The voltage generating device 74 generates a driving
voltage V_{c}(
\overline{r}
) to the position
\overline{r}
according to the gray scale selection signal Lⱼ(
\overline{r}
) and the calibration gamma curve.

Those skilled in the art will readily observe that numerous modifications and alterations of the device may be made while retaining the teachings of the invention. Accordingly, the above disclosure should be construed as limited only by the metes and bounds of the appended claims.

1. A method of compensating for brightness and chromatic aberration of an LCD, the method comprising the following steps:
providing a set of calibration gamma curves; and
applying different driving voltages to corresponding positions of the LCD according to the set of calibration gamma curves so that at a same gray scale and at a same fundamental color, brightness is identical and no chromatic aberration occurs in all the positions of the LCD.

2. The method of claim 1 wherein the step of providing the set of calibration gamma curves comprises:
detecting gamma curves of all the positions of the LCD;
selecting a transmission rate as a basis to define a voltage range for controlling gray scales at each position;
determining the driving voltage of each corresponding position at each gray scale; and
normalizing the driving voltages of all the positions at all gray scales for obtaining the set of calibration gamma curves.

3. The method of claim 2 wherein the step of detecting the gamma curves of all the positions comprises obtaining a gamma curve of a position between any two positions that have known gamma curves by an interpolation method.

4. The method of claim 2 wherein the step of detecting the gamma curves of all the positions comprises obtaining a gamma curve of a position positioned at a center of gravity of three positions that have known gamma curves by utilizing a formula of center of gravity.

5. A circuit architecture for compensating for brightness and chromatic aberration of an LCD comprising:
a gray scale determination device for determining a gray scale of a position and outputting a gray scale selection signal;
a calibration device providing a calibration gamma curve for compensating for brightness and chromatic aberration of the position; and
a voltage generating device for generating a driving voltage to the position according to the gray scale selection signal and the calibration gamma curve.
